(19) United States
(12) Patent Application Publication
(10) Pub. No.: US 2010/0110994 A1
(43) Pub. Date: May 6, 2010

(54) METHOD AND APPARATUS FOR ALLOCATING A PHYSICAL RANDOM ACCESS CHANNEL IN AN OTHOGONAL FREQUENCY DIVISION MULTIPLEXING COMMUNICATION SYSTEM

(75) Inventors: Rapeepat Ratsuk, Hoffman Estates, IL (US); Amitabha Ghosh, Buffalo Grove, IL (US); Vijay Nangia, Algonquin, IL (US); Weimin Xiao, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/261,810

(22) Filed: Oct. 30, 2008

(51) Int. Cl. H04W 72/04; H04B 1/713

(52) U.S. Cl. 370/329; 375/133; 375/E01.033

(57) ABSTRACT

A method and eNode B are disclosed that allocate a Physical random access channel (PRACH) in an Orthogonal Frequency Division Multiplexing communication system. In one embodiment, the eNode B maintains a predetermined location of a PRACH within a sub-frame, which predetermined location is adjacent to a Physical uplink control channel (PUCCH), allocates one or more sub-frames of a radio frame to a PRACH, and receives an access attempt over the PRACH based on the predetermined sub-frame location and the allocated one or more sub-frames. In another embodiment, the eNode B allocates one or more Physical Resource Blocks (PRBs) of one or more sub-frames of a PRACH hopping pattern period to a PRACH and informs a user equipment of the PRBs allocated for the PRACH by transmitting a first parameter informing of a slot configuration and a second parameter informing of a duration of a PRACH hopping period.

### FIELD OF THE INVENTION

The present invention relates generally to Orthogonal Frequency Division Multiplexing (OFDM) communication systems, and, in particular, to a provision of a Physical random access channel in an OFDM communication system.

### BACKGROUND OF THE INVENTION

The 3GPP (Third Generation Partnership Project) Long Term Evolution (LTE) standards propose using Orthogonal Frequency Division Multiple Access (OFDMA) for transmission of data over an air interface. In an OFDMA communication system, a frequency bandwidth employed by the communication system is split into multiple frequency sub-bands, or Physical Resource Blocks (PRBs), during a given time period. Each PRB comprises multiple orthogonal frequency sub-carriers over a given number of OFDM symbols, that are the physical layer channels over which traffic and signaling channels are transmitted in a TDM or TDM/FDM fashion.

Among the physical layer channels proposed for the 3GPP LTE standards is a Physical random access channel (PRACH). However, the 3GPP LTE standards do not provide specific implementations for the PRACH. Therefore, a need exists for a method and apparatus for allocating a PRACH for a 3GPP LTE communication system.

### BRIEF DESCRIPTION OF THE DRAWINGS

FIG. 1 is a block diagram of a wireless communication system in accordance with an embodiment of the present invention.

FIG. 2 is a block diagram of a user equipment of the communication system of FIG. 1 in accordance with an embodiment of the present invention.

FIG. 3 is a block diagram of an eNode B of the communication system of FIG. 1 in accordance with an embodiment of the present invention.

FIG. 4 is a block diagram of an exemplary uplink radio frame in accordance with an embodiment of the present invention.

FIGS. 5-9 are block diagrams of exemplary PRACH allocating patterns in accordance with various embodiments of the present invention.

FIG. 10 is a logic flow diagram of a method for allocating a PRACH in accordance with various embodiments of the present invention.

FIG. 11 is a logic flow diagram of a method for allocating a PRACH in accordance with various other embodiments of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method and an apparatus that allocates a PRACH for a 3GPP LTE communication system, a method and eNode B are disclosed that allocate a Physical random access channel (PRACH) in an Orthogonal Frequency Division Multiplexing (OFDM) communication system. In one embodiment, the eNode B maintains a predetermined location of a PRACH within a sub-frame, which predetermined location is adjacent to a Physical uplink control channel (PUCCH), allocates one or more sub-frames of a radio frame to the PRACH, and receives an access attempt over the PRACH based on the predetermined sub-frame location and the allocated one or more sub-frames. In another embodiment, the eNode B allocates one or more Physical Resource Blocks (PRBs) of one or more sub-frames of a PRACH hopping pattern period to a PRACH and informs a user equipment of the PRBs allocated for the PRACH by transmitting a first parameter informing of a slot configuration and a second parameter informing of a duration of a PRACH hopping period.

That is, generally, an embodiment of the present invention encompasses a method for allocating a PRACH in an OFDM communication system. The method includes maintaining a predetermined location of a PRACH within a sub-frame, which predetermined location is adjacent to a PUCCH, allocating one or more sub-frames of a radio frame to the PRACH, and receiving an access attempt over the PRACH based on the predetermined sub-frame location and the allocated one or more sub-frames.

Another embodiment of the present invention encompasses a method for allocating a PRACH in an OFDM communication system. The method includes allocating one or more PRBs of one or more sub-frames of a PRACH hopping pattern period to a PRACH and informing a user equipment of the PRBs allocated for the PRACH by transmitting a first parameter informing of a slot configuration and a second parameter informing of a duration of a PRACH hopping period.

Yet another embodiment of the present invention encompasses an eNode B that is capable of allocating a PRACH in an OFDM communication system, wherein the eNode B is configured to maintain a predetermined location of a PRACH within a sub-frame, which predetermined location is adjacent to a PUCCH, allocate one or more sub-frames of a radio frame to the PRACH, and receive an access attempt over the PRACH based on the predetermined sub-frame location and the allocated one or more sub-frames.

Still another embodiment of the present invention encompasses an eNode B that is capable of allocating a PRACH in an OFDM communication system, wherein the eNode B is configured to allocate one or more PRBs of one or more sub-frames of a PRACH hopping pattern period to a PRACH and inform a user equipment of the PRBs allocated for the PRACH by transmitting a first parameter informing of a slot configuration and a second parameter informing of a duration of a PRACH hopping period.

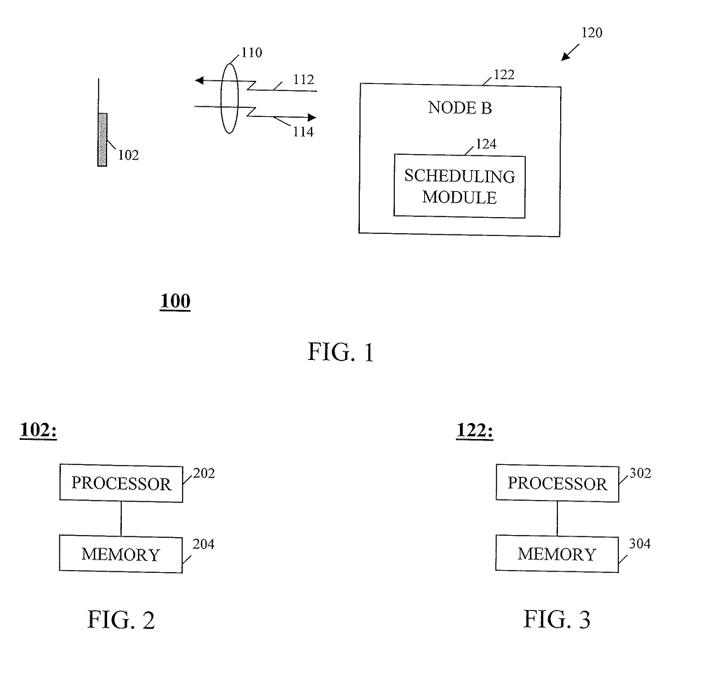

The present invention may be more fully described with reference to FIGS. 1-11. FIG. 1 is a block diagram of a wireless communication system 100 in accordance with an embodiment of the present invention. Communication system 100 includes at least one user equipment (UE) 102, such as but not limited to a cellular telephone, a radio telephone, a personal digital assistant (PDA), laptop computer, or personal computer with radio frequency (RF) capabilities, or a wireless modem that provides RF access to digital terminal equipment (DTE) such as a laptop computer. Communication system 200 further includes a Radio Access Network (RAN) 120 that provides communication services to users equipment, such as MS 102, residing in a coverage area of the RAN via an air interface 110.

RAN 120 includes an eNode B 122 in wireless communication with each UE, such as UE 102, service by the RAN. eNode B 122 includes a scheduling module 124 that performs the allocating functions described herein as being performed by the eNode B. In other embodiments of the invention, the scheduling module may be implemented in a network element separate from, and in communication with, the eNode B. For example, if RAN 120 includes an access network controller, the scheduling module may be implemented in such a controller. Air interface 110 comprises a downlink 112 and an uplink 114. Each of downlink 112 and uplink 114 comprises multiple physical communication channels, including at least one signaling channel and at least one traffic channel. More particularly, downlink 112 includes a Physical broadcast channel (PBCH), a Physical downlink control channel (PDCCH), and a Physical downlink shared channel (PDSCH), and uplink 114 includes a Physical random access channel (PRACH), a Physical uplink control channel (PUCCH), and a Physical uplink shared channel (PUSCH).

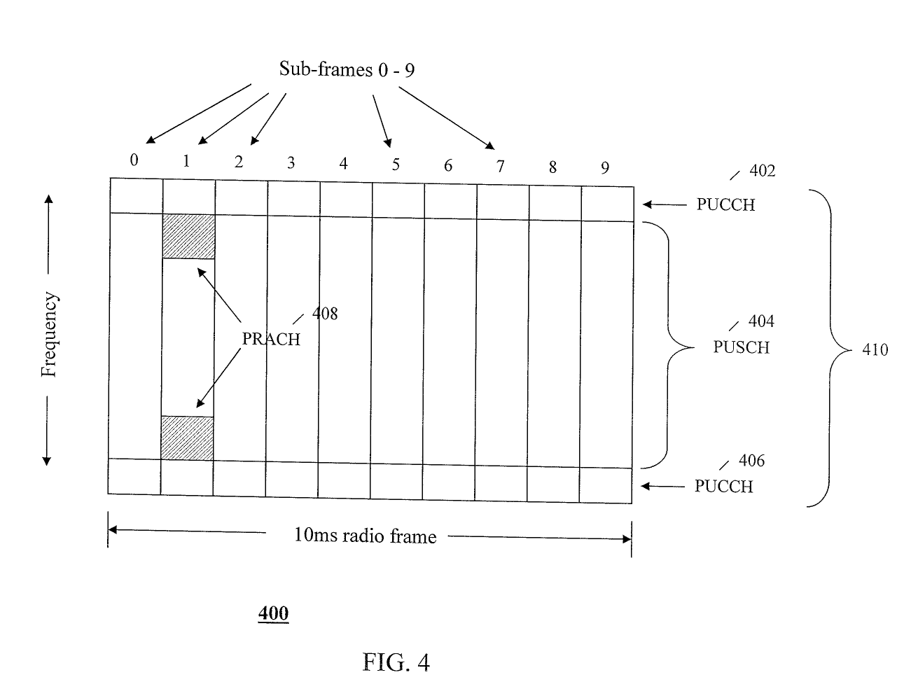

FIG. 2 is a block diagram of UE 102 in accordance with an embodiment of the present invention. UE 102 includes a processor 202, such as one or more microprocessors, microcontrollers, digital signal processors (DSPs), combinations thereof or such other devices known to those having ordinary skill in the art. The particular operations/functions of processor 202, and thus of UE 102, is determined by an execution of software instructions and routines that are stored in a respective at least one memory device 204 associated with the processor, such as random access memory (RAM), dynamic random access memory (DRAM), and/or read only memory (ROM) or equivalents thereof, that store data and programs that may be executed by the corresponding processor.

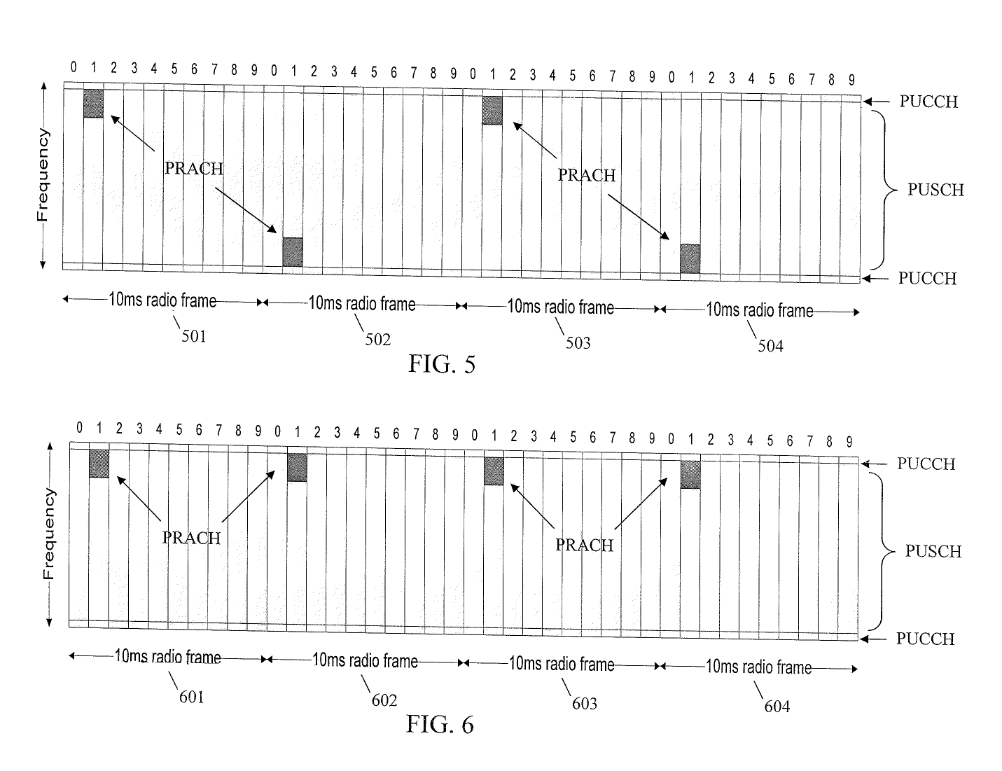

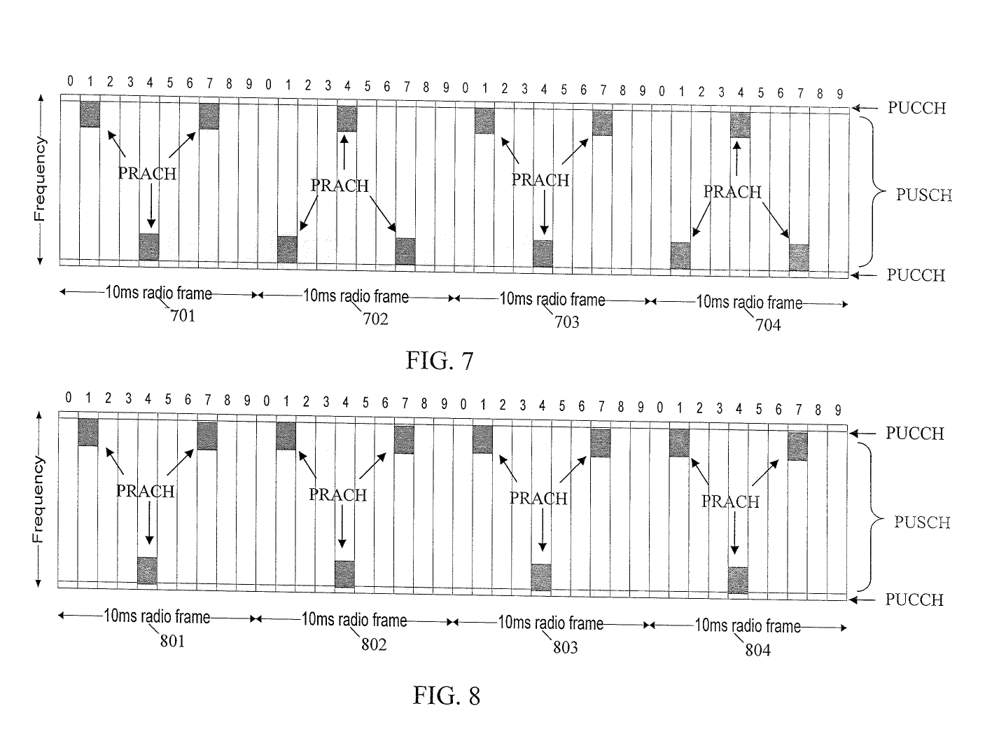

FIG. 3 is a block diagram of eNode B 122 in accordance with an embodiment of the present invention. eNode B 122 includes a processor 302, such as one or more microprocessors, microcontrollers, digital signal processors (DSPs), combinations thereof or such other devices known to those having ordinary skill in the art. The particular operations/functions of processor 302, and respectively thus of allocating function 124, are determined by an execution of software instructions and routines that are stored in an at least one memory device 304 associated with the processor, such as random access memory (RAM), dynamic random access memory (DRAM), and/or read only memory (ROM) or equivalents thereof, that store data and programs that may be executed by the corresponding processor. Among the software instructions and routines that are stored in at least one memory device 304 of eNode B 122 is scheduling module 124, which scheduling module is implemented by processor 302 based on the software instructions and routines stored in the at least one memory device. Preferably, the allocating and bandwidth allocation described herein as being performed by the eNode B are performed by scheduling module 124. Furthermore, each of UE 102 and eNode B 122 maintains a slot configuration table in their respective at least one memory device 204, 304. The slot configuration table comprises a list of PRACH repeat patterns, each pattern associated with an index value. The variety of PRACH repeat patterns are up to a designer of system 100, and exemplary PRACH repetition patterns are described in greater detail below with respect to FIGS. 4-9.

The embodiments of the present invention preferably are implemented within UE 102 and eNode B 122, and more particularly with or in software programs and instructions stored in the respective at least one memory device 204, 304 and executed by respective processors 202, 302 of the UE and eNode B. However, one of ordinary skill in the art realizes that the embodiments of the present invention alternatively may be implemented in hardware, for example, integrated circuits (ICs), application specific integrated circuits (ASICs), and the like, such as ASICs implemented in one or more of UE 102 and eNode B 122. Based on the present disclosure, one skilled in the art will be readily capable of producing and implementing such software and/or hardware without undo experimentation.

Communication system 100 comprises a wideband packet data communication system that employs an Orthogonal Frequency Division Multiplexing (OFDM) modulation scheme for transmitting data over air interface 210. Communication system 100 is an Orthogonal Frequency Division Multiple Access (OFDMA) communication system, wherein a frequency bandwidth employed by the communication system is split into multiple frequency sub-bands, or Physical Resource Blocks (PRBs), during a given time period. Each PRB comprises multiple orthogonal frequency sub-carriers over a given number of OFDM symbols, or time slots, that are the physical layer channels over which traffic and signaling channels are transmitted in a TDM or TDM/FDM fashion. From another perspective, each PRB includes multiple resource elements, wherein each resource element comprises a frequency sub-carrier over an OFDM symbol. In addition, communication system 100 preferably comprises a 3GPP (Third Generation Partnership Project) Long Term Evolution (LTE) communication system and RAN 120 is an E-UTRAN (Evolutionary UMTS Terrestrial Radio Access Network), which LTE standards specify wireless telecommunications system operating protocols, including radio system parameters and call processing procedures. However, those who are of ordinary skill in the art realize that communication system 100 may operate in accordance with any wireless telecommunication system Orthogonal Frequency Division Multiplexing (OFDM) communication system that employs a PRACH.

In communication system 100, when a UE, such as UE 102, attempts to access a RAN, such as RAN 120, for example, as a result of activating in a coverage area of the RAN or during a handover to the RAN, the UE transmits a signal on the uplink PRACH. In order to transmit on the PRACH, the UE must know where, in the time and frequency domains employed by communication system 100, the PRACH is located. However, the 3GPP LTE standards do not provide specific implementations for the PRACH. As a result, communication system 100 provides for a UE to maintain and/or an eNode B to broadcast parameters that will identify, for the UE, where the PRACH is located.

In one embodiment of the present invention, communication system 100 provides for the PRACH to be located adjacent, in frequency, to the PUCCH. Referring now to FIG. 4, a block diagram is provided that depicts an exemplary uplink radio frame 400 in accordance with an embodiment of the present invention. Radio frame 400 has a duration of 10 millisecond (ms) and is implemented over a frequency bandwidth 410, that is, the frequency sub-carriers, of the communication system. Radio frame 400 is sub-divided, in the time domain, into multiple sub-frames (10 sub-frames, in FIG. 4), that is, sub-frames 0-9. In each sub-frame 0-9, eNode B 122, and in particular scheduling module 124, allocates one or more sub-carriers, and more particularly one or more PRBs, of frequency bandwidth 410 to the PUCCH 402 and allocates other sub-carriers, that is, PRBs, of the frequency bandwidth to the PUSCH 404. More particularly, one or more PRBs at each of the edges of frequency bandwidth 410 are allocated to PUCCH 402 and the remaining PRBs may be allocated to the PUSCH 404.

In the uplink radio frame embodiment depicted in FIG. 4, the PRACH does not frequency hop, that is, the PRACH is always allocated for a PRB adjacent to the PUCCH 402 at the top of the frequency bandwidth, or for a PRB adjacent to the PUCCH 406 at the bottom of the frequency bandwidth, and it does not hop between the two. In one such non-frequency hopping embodiment, the eNode B 122 allocates the PRACH, that is, PRACH 408, for a same position in every uplink radio frame, such as in a second sub-frame, that is, sub-fame 1, and adjacent to the PUCCH. This location can be preprogrammed into the UE, or this location can be broadcast by each eNode B in communication system 100 over a common or shared control channel or over a broadcast channel, for example, by broadcasting a PRB index value associated with this PRB. Furthermore, as the PRACH is always allocated for a PRB adjacent to a PUCCH 402, 406 eNode B 122 may broadcast locations of the PUCCH (if not already known to the UE) and UE 102 may determine a location of the PRACH based on the PUCCH location, as the UE may know (that is, maintain in the at least one memory device 204 of the UE) that the PRACH is adjacent to the PUCCH, and may further know which sub-frame is always allocated to the PRACH. For example, UE 102 may know that the PRACH always occurs in a predetermined sub-frame, for example, the second sub-frame (that is, sub-frame 1), and adjacent to the PUCCH at the top of the bandwidth.

In another such non-frequency hopping embodiment, the PRACH may time hop, for example, may be allocated for once every ‘x’ sub-frames, with a given hopping pattern period. For example, the PRACH may be allocated for every third sub-frame and with a 10 ms hopping pattern period, resulting a PRACH occurring in sub-frames 1, 4, and 7 of a radio frame. The pattern would begin anew with each radio frame (the 10 ms hopping pattern period). The hopping pattern period may be predetermined and maintained in the at least one memory devices 204, 304 of UE 102 and eNode B 122, and all that the eNode B would have to broadcast would be the repeat period of the PRACH (defined below as a slot configuration value) in each hopping pattern period. Again, as the PRACH is always allocated for a PRB adjacent to a PUCCH 402, 406, UE 102 then may determine a location of the PRACH based on the broadcast hopping pattern period and, if not already known to the UE, a broadcast location of the PUCCH. For example, UE 102 may know that, during a hopping pattern period, the PRACH always first occurs in a pre-determined sub-frame, for example, the second sub-frame (that is, sub-frame 1), of the period and at the PUCCH at the top of the bandwidth.

In this way, the location of the PRACH at each eNode B can easily be determined by all UEs serviced by communication system 100, even when handing off to a new cell/eNode B, as the PRACH will be located in a same frequency location in all cells of the communication system. Also, by locating the PRACH adjacent to the PUCCH instead of distributing the PRACH among various sub-carriers throughout the PUSCH, segmentation of the PUSCH is avoided and a UE may locate the PRACH without the need to broadcast complete information concerning the location of the PRACH, as the UE may determine a location of the PRACH based on a location of the PUCCH. Furthermore, since the PRACH transmission power typically is low, the PRACH should minimally interfere with the PUCCH despite the adjacent location of the PRACH.

In other embodiments of the present invention, the PRACH may frequency hop and time hop. In such frequency hopping embodiments, eNode B 122 may allocate the PRACH for PRBs based on predetermined PRACH hopping patterns. In one such embodiment of the present invention, a PRACH hopping pattern may be indentified by two PRACH hopping pattern parameters, that is, a first hopping pattern parameter that indicates how often the PRACH is allocated (a slot configuration parameter), that is, a PRACH repetition rate, and a second hopping pattern parameter that indentifies a duration of a PRACH hopping pattern period. Preferably, the PRACH hopping pattern period is an integer number of radio frames. The slot configuration parameter comprises an index value that indexes to the slot configuration table maintained by each of eNode B 122 and UE 102 in their respective at least one memory devices 204, 304. The slot configuration table maintains a PRACH repeat pattern in association with each index value. By conveying a slot configuration table index value to UE 102, eNode B 122 is able to indicate to the UE the repeat pattern of a PRACH over a hopping pattern period.

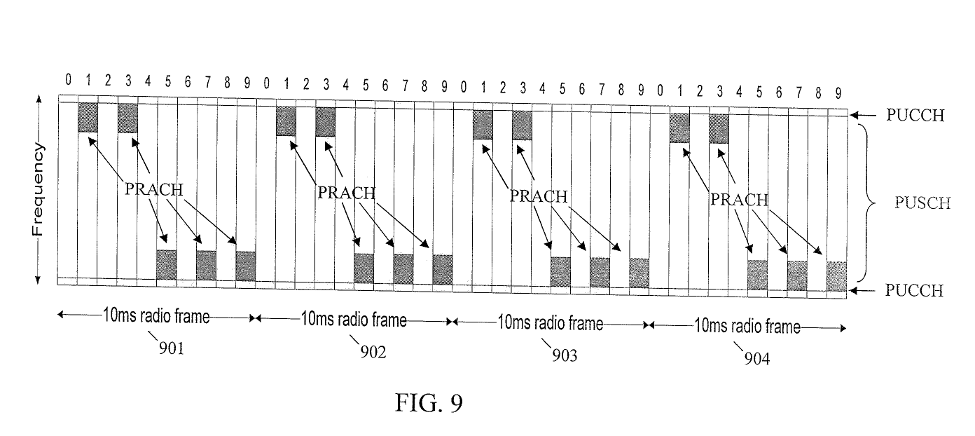

FIGS. 5-8 depict exemplary PRACH allocating patterns in accordance with various embodiments of the present invention. In the two-parameter hopping patterns depicted in FIGS. 5-8, it is predetermined that the PRACH hops between a PRB adjacent to the PUCCH at the top of the frequency bandwidth and a PRB adjacent to the PUCCH at the bottom of frequency bandwidth with every occurrence of the PRACH and for the duration of a hopping pattern period. However, other pre-determined hopping patterns may be used without departing from the spirit and scope of the present invention.

For example, in FIG. 5, eNode B 122 allocates the PRACH for a hopping pattern of every tenth sub-frame (the PRACH is allocated for once every tenth sub-frame), corresponding to a slot configuration index value equal to 3, and a PRACH hopping pattern period of 40 ms, corresponding to radio frames 501-504 (in other words, the hopping pattern period starts at sub-frame 0 of radio frame 501 and ends at sub-frame 9 of radio frame 504). As a result, the PRACH is allocated for sub-frame 1 of each radio frame, and the hops back and forth between the top of the frequency bandwidth and the bottom of the frequency bandwidth for 4 radio frames, or 40 ms, before the pattern restarts. By way of another example, in FIG. 6, eNode B 122 again allocates the PRACH for a hopping pattern of every tenth sub-frame (the PRACH is allocated for once every tenth sub-frame), again corresponding to a slot configuration index value equal to 3, but a PRACH hopping pattern period of only 10 ms, that is, the hopping pattern period is one radio frame (in other words, the hopping pattern starts at sub-frame 0 of each radio frame 601-604 and ends at sub-frame 9 of the same radio frame). As a result, the PRACH again is allocated for sub-frame 1 of each radio frame, but because the hopping pattern restarts every 10 ms, the PRACH only occurs at the top of the frequency bandwidth.

In yet another example of a PRACH allocating scheme, in FIG. 7 eNode B 122 allocates the PRACH for a slot configuration index value equal to 9, which corresponds to a hopping pattern of 3/3/4, that is, a three sub-frame hop, followed by another three sub-frame hop, followed by a four sub-frame hop, and a PRACH hopping pattern period of 40 ms, corresponding to radio frames 701-704 (which hopping pattern starts at sub-frame 0 of radio frame 701 and ends at sub-frame 9 of radio frame 704). As a result, the PRACH is allocated for sub-frame 1 of each radio frame 701-704, sub-frame 4 of each radio frame 701-704 (a three sub-frame hop), sub-frame 7 of each radio frame 701-704 (a three sub-frame hop), and then sub-frame 1 of the next radio frame (a four sub-frame hop). And again the PRACH hops back and forth between the top of the frequency bandwidth and the bottom of the frequency bandwidth with each occurrence. In still another example of a PRACH allocating scheme, in FIG. 8 eNode B 122 again allocates the PRACH for a slot configuration index value equal to 9, corresponding to a 3/3/4 hopping pattern, but a PRACH hopping pattern period of only 10 ms, that is, the hopping pattern period is one radio frame (which hopping pattern starts at sub-frame 0 of each radio frame 801-804 and ends at sub-frame 9 of the same radio frame). As a result, the PRACH again is allocated for sub-frames 1, 4, and 7 of each radio frame, hopping between the top of the frequency bandwidth and the bottom of the frequency bandwidth with each occurrence. However, since the hopping pattern period is only 10 ms, the hopping pattern restarts with each new radio frame and, as a result, the PRACH occurs adjacent to the PUCCH at the top of the frequency bandwidth in sub-frame 1 of each radio frame 801-804.

In another embodiment of the present invention, a PRACH hopping pattern may be indentified by three PRACH hopping pattern parameters, that is, the slot configuration parameter and the hopping pattern period parameter identified above, and a third PRACH hopping pattern parameter (‘n’). The third PRACH hopping pattern parameter is a PRACH frequency hopping parameter that indicates how often the PRACH frequency hops. That is, the frequency hopping parameter indicates when the PRACH is to switch (every n^{th} sub-frame) from PRBs adjacent to the PUCCH at the top of the frequency bandwidth to PRBs adjacent to the PUCCH at the bottom of frequency bandwidth, or visa versa.

For example, in FIG. 9, eNode B 122 allocates the PRACH for a slot configuration index value equal to 12, which corresponds to a hopping pattern of every two sub-frames during a hopping pattern period, and a hopping pattern period of 10 ms, that is, the hopping pattern period is one radio frame (which hopping pattern starts at sub-frame 0 of each radio frame 901-904 and ends at sub-frame 9 of the same radio frame). In addition, eNode B 122 allocates the PRACH for a third hopping pattern parameter of ‘n’=5, indicating that the PRACH switches from PRBs adjacent to the PUCCH at the top of the frequency bandwidth to PRBs adjacent to the PUCCH at the bottom of frequency bandwidth, and visa versa, only every fifth sub-frame of a hopping pattern. As a result, the PRACH is allocated for a PRB adjacent to the PUCCH at the top of the frequency bandwidth whenever the PRACH occurs in sub-frames 0-4 of a radio frame, that is, in sub-frames 1 and 3, and is allocated for a PRB adjacent to the PUCCH at the bottom of the frequency bandwidth whenever the PRACH occurs in sub-frames 5-9 of a radio frame, that is, in sub-frames 5, 7, and 9. The hopping pattern then restarts in each next radio frame.

Once again, and with respect to the frequency hopping embodiments depicted in FIGS. 5-9, if the PRACH is always allocated for a PRB adjacent to a PUCCH, UE 102 may determine a location of the PRACH based on the broadcast hopping pattern parameters and, if not already known to the UE, a broadcast location of the PUCCH. For example, UE 102 may know that, during a hopping pattern period, the PRACH first occurs in pre-determined sub-frame, for example, the second sub-frame (that is, sub-frame 1), of the hopping pattern period and at the PUCCH at the top of the bandwidth. Based on this knowledge and on the received parameters, a UE may determine all other locations of the PRACH.

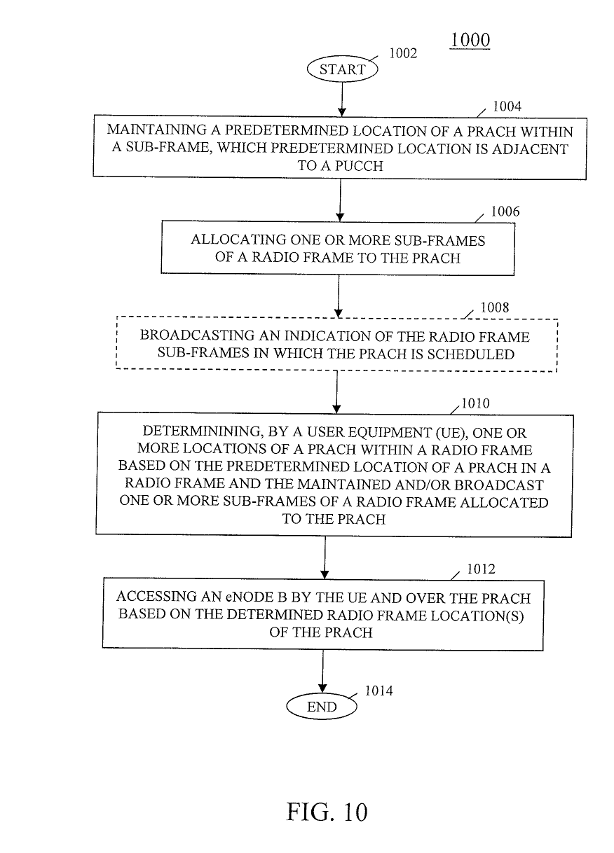

Referring now to FIG. 10, a logic flow diagram 1000 is provided that depicts a allocating of a PRACH by communication system 100 in accordance with non-frequency hopping embodiments of the present invention. Logic flow diagram 1000 begins (1002) with each of UE 102 and eNode B 122 maintaining (1004), in an at least one memory device 204, 304 of the UE and eNode B, a predetermined location of a PRACH within a sub-frame. Preferably, the predetermined location is either a PRB adjacent to a PUCCH at the top of frequency bandwidth 410 of communication system 100, that is, adjacent to PUCCH 402, or a PRB adjacent to a PUCCH at the bottom of the frequency bandwidth, that is, adjacent to PUCCH 406.

eNode B further allocates (1006) one or more sub-frames of a radio frame to the PRACH. In one embodiment of the invention, the one or more sub-frames are predetermined and their identities are known to, that is, maintained in the at least one memory devices 204, 304 of, the UE and eNode B. In another embodiment of the present invention, the one or more sub-frames are not known, in advance, to UE 102, and eNode B 122 allocates one or more sub-frames of a radio frame to the PRACH and broadcasts (1008), over a downlink broadcast channel or a common or shared control channel, an indication of the radio frame sub-frames allocated to the PRACH, such as sub-frame 1, or sub-frames 1 and 5. Based on the maintained predetermined location of a PRACH within a sub-frame, and the allocated one or more sub-frames of a radio frame allocated to the PRACH, UE 102 determines (1012) one or more locations (PRBs) allocated for the PRACH within a radio frame. When a user of the UE wishes to access the eNode B, the UE transmits (1014), and the eNode B receives, an access attempt over one or more allocated PRACH PRB(s) based on the determine radio frame location(s) (PRB(s)) of the PRACH. The UE may select the one or more allocated PRACH PRB(s) over which to make the access attempt based on downlink radio conditions measured by the UE, which conditions may be correlated to the uplink by the UE. Logic flow 1000 then ends (1016).

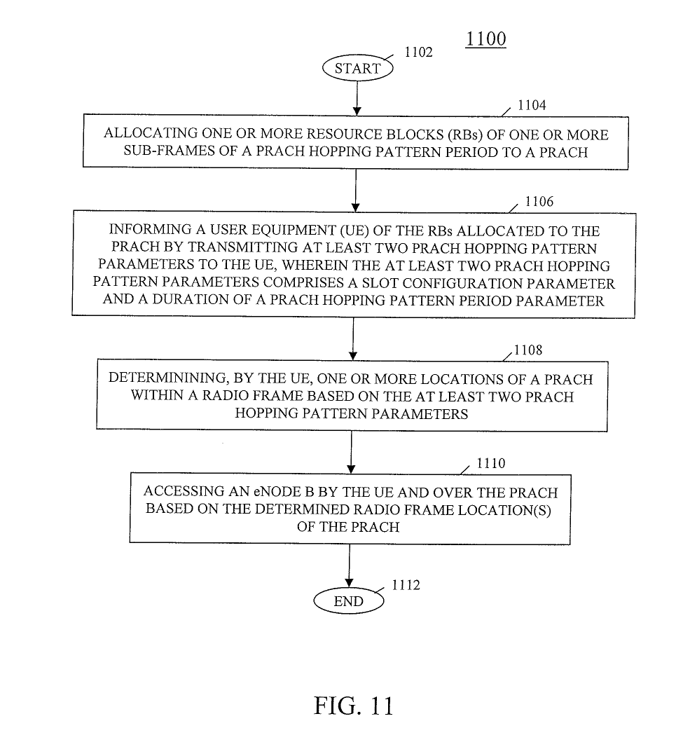

Referring now to FIG. 11, a logic flow diagram 1100 is provided that depicts a allocating of a PRACH by communication system 100 in accordance with frequency hopping embodiments of the present invention. Logic flow diagram 1100 begins (1102) when eNode B allocates (1104) one or more PRBs of one or more sub-frames of a PRACH hopping pattern period to the PRACH. Preferably, the PRACH hopping pattern period comprises an integer number of radio frames and each of the one or more PRBs is adjacent to the PUCCH at the top of the frequency bandwidth or adjacent to the PUCCH at the bottom of the frequency bandwidth. eNode B 122 then informs (1106) UE 102 of the PRBs allocated to the PRACH by transmitting, to the UE, at least two PRACH hopping pattern parameters, that is, a first hopping pattern parameter that indicates how often the PRACH is allocated (a slot configuration parameter), that is, a PRACH repetition rate, and a second hopping pattern parameter that indentifies a duration of a PRACH hopping pattern period. The slot configuration parameter comprises an index value that indexes to the slot configuration table maintained by each of eNode B 122 and UE 102 in their respective at least one memory devices 204, 304. The slot configuration table maintains a PRACH repeat pattern in association with each index value. By conveying a slot configuration table index value to UE 102, eNode B 122 is able to indicate to the UE the repeat pattern of a PRACH over a hopping pattern period.

In another embodiment of the present invention, at step 1106, eNode B 122 may inform UE 102 of the PRBs allocated to the PRACH by conveying a third PRACH hopping pattern parameter in addition to the two PRACH hopping pattern parameters described above. The third PRACH hopping pattern parameter (‘n’) is a PRACH frequency hopping parameter, that is, an indicator of how often the PRACH frequency hops, and more particularly hops from a PRB adjacent to the PUCCH at the top of the frequency bandwidth to a PRB adjacent to the PUCCH at the bottom of frequency bandwidth, or visa versa.

Based on the at least two PRACH hopping pattern parameters, UE 102 determines (1108) one or more locations (PRBs) allocated, by eNode B 122, for the PRACH within a radio frame. When a user of the UE wishes to access the eNode B, the UE transmits (1110), and the eNode B receives, an access attempt over one or more allocated PRACH PRB(s) based on the determine radio frame location(s) (PRB(s)) of the PRACH. The UE may select the one or more allocated PRACH PRB(s) over which to make the access attempt based on downlink radio conditions measured by the UE, which conditions may be correlated to the uplink by the UE. Logic flow 1100 then ends (1112).

By providing a PRACH that is located adjacent to a PUCCH, as opposed to distributing the PRACH among various sub-carriers throughout the PUSCH, communication system 100 avoids segmentation of the PRACH. Since the PRACH transmission power typically is low, the PRACH should minimally interfere with the PUCCH despite the adjacent location of the PRACH. Further, by placing the PRACH in a predetermined frequency location in each radio frame in one embodiment, and further in a predetermined sub-frame of each radio frame, a UE can easily determine the location of the PRACH, even when handing off to a new cell/eNode B, as the PRACH will be located in a same location in all cells of the communication system. In other embodiments of the invention, a location of PRACH can be easily determined by a UE based on a sub-frame or PRB identifier known to the UE or broadcast by an eNode B. In still other embodiments of the invention, a location of PRACH can be determined by a UE based on two or three hopping pattern parameters broadcast by the eNodeB, and in particular a first PRACH hopping pattern parameter that indicates how often the PRACH is allocated (a slot configuration parameter), that is, a PRACH repetition rate, a second PRACH hopping pattern parameter that indentifies a duration of a PRACH hopping pattern period, and a third PRACH hopping pattern parameter that identifies a frequency hopping pattern of the PRACH. Thus a simple scheme is provided by which an eNode B can inform a UE of a location of a PRACH in all time slots of the communication system, which schemes provide the benefit of time, and in some embodiments frequency, diversity for the PRACH.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions.

What is claimed is:

1. A method for allocating a Physical random access channel (PRACH) in an Orthogonal Frequency Division Multiplexing communication system, the method comprising:
maintaining a predetermined location of a PRACH within a sub-frame, which predetermined location is adjacent to a Physical uplink control channel (PUCCH);
allocating one or more sub-frames of a radio frame to the PRACH; and
receiving an access attempt over the PRACH based on the predetermined sub-frame location and the allocated one or more sub-frames.

2. The method of claim 1, wherein allocating one or more sub-frames of a radio frame to the Physical random access channel (PRACH) comprises:
allocating, by an eNode B, one or more sub-frames of a radio frame to the PRACH; and
broadcasting, by an eNode B, an indication of the allocated one or more sub-frames of a radio frame.

3. The method of claim 1, wherein the access attempt is received from a user equipment and wherein the one or more sub-frames are predetermined and are maintained by the user equipment and a serving eNode B.

4. The method of claim 1, wherein allocating a Physical random access channel (PRACH) for one or more sub-frames of a radio frame comprises:
allocating, by an eNode B, one or more sub-frames of a radio frame to the PRACH; and
broadcasting, by an eNode B, an indication of the allocated Physical Resource Blocks for the PUCCH; and
determining, by a UE, the location of the PRACH based on the broadcast location of the PUCCH.

5. The method of claim 1, wherein the location of a PRACH hops in a predetermined pattern between two frequency locations adjacent to a Physical uplink control channel (PUCCH).

6. The method of claim 5, wherein the hopping pattern is repeated every radio frame.

7. The method of claim 1, wherein the access attempt is received from a user equipment and wherein the user equipment selects the PRACH based on downlink radio conditions.

8. A method for allocating a Physical random access channel (PRACH) in an Orthogonal Frequency Division Multiplexing communication system, the method comprising:
allocating one or more Physical Resource Blocks (PRBs) of one or more sub-frames of a PRACH hopping pattern period to a PRACH; and
informing a user equipment of the PRBs allocated for the PRACH by transmitting a first parameter informing of a slot configuration and a second parameter informing of a duration of a PRACH hopping period.

9. The method of claim 8, wherein the first parameter comprises an index to a slot configuration table.

10. The method of claim 8, wherein the slot configuration comprises a repeat period of the Physical random access channel.

11. The method of claim 8, wherein the Physical random access channel hopping period is an integer number of radio frames.

12. The method of claim 8, wherein each Physical random access channel Resource Block is adjacent to a Physical uplink control channel (PUCCH).

13. The method of claim 8, further comprising informing the user equipment of the PRBs allocated for the PRACH by transmitting a third parameter comprising an indication of how often the PRACH frequency hops.

14. The method of claim 8, further comprising receiving an access attempt by the user equipment over the PRACH based on the transmitted first and second parameters.

15. The method of claim 14, wherein the user equipment selects the PRACH for the access attempt based on downlink radio conditions.

16. An eNode B that is capable of allocating a Physical random access channel (PRACH) in an Orthogonal Frequency Division Multiplexing communication system, wherein the eNode B is configured to maintain a predetermined location of a PRACH within a sub-frame, which predetermined location is adjacent to a Physical uplink control channel (PUCCH), allocate one or more sub-frames of a radio frame to the PRACH , and receive an access attempt over the PRACH based on the predetermined sub-frame location and the allocated one or more sub-frames.

17. The eNode B of claim 16, wherein the eNode B is configured to broadcast an indication of the allocated one or more sub-frames of a radio frame.

18. The eNode B of claim 16, wherein the one or more sub-frames are predetermined and are maintained in an at least one memory device of the eNode B.

19. An eNode B that is capable of allocating a Physical random access channel (PRACH) in an Orthogonal Frequency Division Multiplexing communication system, wherein the eNode B is configured to allocate one or more Physical Resource Blocks (PRBs) of one or more sub-frames of a PRACH hopping pattern period to a PRACH and inform a user equipment of the PRBs allocated for the PRACH by transmitting a first parameter informing of a slot configuration and a second parameter informing of a duration of a PRACH hopping period.

20. The eNode B of claim 19, wherein the first parameter comprises an index to a slot configuration table.

21. The eNode B of claim 19, wherein the slot configuration comprises a repeat period of the Physical random access channel.

22. The eNode B of claim 19, wherein the Physical random access channel hopping period is an integer number of radio frames.

23. The eNode B of claim 19, wherein each Physical random access channel Physical Resource Block is adjacent to a Physical uplink control channel (PUCCH).

24. The eNode B of claim 19, further comprising informing the user equipment of the Physical Resource Blocks allocated for the user equipment of the Physical random access channel (PRACH) by transmitting a third parameter comprising an indication of how often the PRACH frequency hops.

25. The eNode B of claim 19, further comprising receiving an access attempt from the user equipment over the Physical random access channel based on the transmitted first and second parameters.
